(19) United States
(12) Patent Application Publication
(10) Pub. No.: US 2015/0118584 A1
(43) Pub. Date: Apr. 30, 2015

(54) CATHODE FOR A LITHIUM/AIR BATTERY, COMPRISING A BILAYER STRUCTURE OF DIFFERENT CATALYSTS AND LITHIUM/AIR BATTERY COMPRISING THIS CATHODE

(71) Applicant: COMMISSARIAT A L'ENERGIE ATOMIQUE ET AUX ENERGIES ALTERNATIVES, Paris (FR)

(72) Inventors: Caroline Rozain, Grenoble (FR); Nicolas Guillet, Pizancon (FR)

(73) Assignee: COMMISSARIAT A L'ENERGIE ATOMIQUE ET AUX ENERGIES ALTERNATIVES, PARIS (FR)

(21) Appl. No.: 14/403,530

(22) PCT Filed: May 20, 2013
(86) PCT No.: PCT/EP2013/060323

§ 371 Date: Nov. 24, 2014

(30) Foreign Application Priority Data
May 25, 2012 (FR) 1254834

(51) Int. Cl. H01M 4/90; H01M 4/92; H01M 4/86; H01M 12/08

(52) U.S. Cl. CPC H01M 4/9075; H01M 12/08; H01M 4/925; H01M 4/9041; H01M 4/8668; H01M 2004/8689; H01M 2300/0082
USPC 429/405

(57) ABSTRACT

A catalytic cathode, intended for a lithium-air battery comprising catalytic particles supported on electron-conducting particles, comprises a first face intended to be in contact with an ion-conducting material and a second face intended to be in contact with atmospheric oxygen, and comprises at least: a first catalytic layer intended to be in contact with the ion-conducting material, and; a second catalytic layer intended to be in contact with atmospheric oxygen, characterized in that: said first layer comprises first entities of catalytic particles promoting the reaction for the oxidation of lithium-based products, said entities being based on cobalt or on nickel; said second catalytic layer comprises second entities of catalytic particles promoting the reaction for the reduction of oxygen, said second entities being based on manganese or on silver or on platinum. A lithium-air battery comprising the cathode is also provided.

The field of the invention is that of batteries, which are devices which make it possible to directly convert energy stored in chemical form into electrical energy.

In the case of lithium-air batteries, the electrical energy is produced by oxidation of lithium and reduction of oxygen. In view of the very high energy density of the lithium-molecular oxygen pair, this technology can potentially achieve useable energy densities of the order of 1700 Wh/kg, i.e. approximately 10 times greater than lithium-ion batteries [G. Girishkumar, B. McCloskey, A. C. Luntz, S. Swanson and W. Wilcke, “Lithium—Air Battery: Promise and Challenges”, J. Phys. Chem. Lett., 2010, 1, 2193-2203: DOI: 10.1021/z1005384].

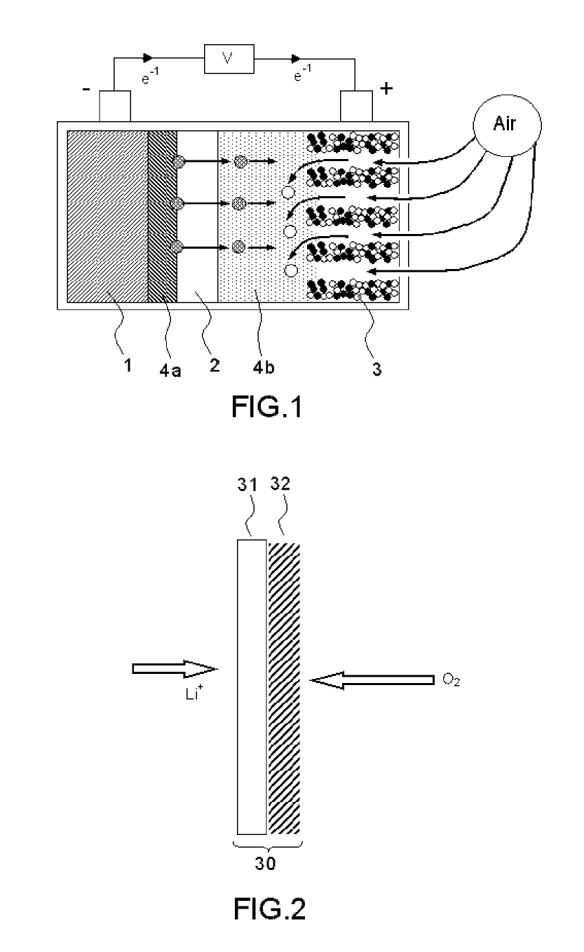

This type of battery is composed of a negative electrode of lithium metal and of a compartment fed with oxygen, separated by a material which conducts lithium ions. When the battery produces an electric current (discharging), the negative electrode is the site of an oxidation reaction of the lithium. The lithium ions thus produced will pass through the electrolyte and will combine with the products of the reduction of the oxygen at the positive electrode. During recharging, the reaction products accumulated on the positive electrode during discharging will reform lithium ions and will give off oxygen. FIG. 1 illustrates such a system, demonstrating: a lithium anode 1 capable of releasing lithium ions, an organic electrolyte 4a separated from an aqueous electrolyte 4b by a membrane 2 which conducts lithium ions, and a catalytic air cathode 3.

When the battery produces an electric current (discharging), the negative electrode is the site of an oxidation reaction of the lithium. The lithium ions thus produced will pass through the electrolyte and will combine with the products of the reduction of the oxygen at the positive electrode. During recharging, the reaction products accumulated on the positive electrode during discharging will reform lithium ions and will give off oxygen.

In the lithium-air battery, the positive electrode has to meet several criteria and provide:
a broad path for diffusion of the oxygen as far as the reaction interface;
good conductivity of the lithium ions;
excellent electrical conductivity;
good stability over time.

This is because the reactions for charging and discharging the battery can only take place when the electrolyte, the electrons and the gas molecules coexist at the same interface. Furthermore, during the operation of the lithium-air battery, the positive electrode is the site of reactions for charging and discharging the battery. A catalyst which promotes these two reactions has to be used.

The positive electrodes presented in the literature are for the most part composed of a mixture of carbon, of a binder, such as PTFE (polytetrafluoroethylene (Teflon®)) or PVDF (polyvinylidene fluoride), and of a catalyst, such as cobalt oxide or manganese oxide. The use of just one catalyst distributed in the body of the electrode, as described in the patent US 2011/0104576 A1, only makes it possible to improve just one of the reactions (charging or discharging) and thus greatly limits the performance of the battery.

Furthermore, as a result of the composition of the positive electrodes (carbon-based support), the lithium-air batteries using an aqueous electrolyte exhibit a very limited number of charging and discharging cycles due to the corrosion by the water of the catalytic support made of carbon. This is because, in an acidic medium, the carbon corrodes according to the reaction:

C+2H₂O⇄CO₂+4H⁺+4e⁻ (1)

The oxidation/reduction potential of this reaction is approximately 0.2V vs. SHE.

In a basic medium, three different corrosion regimes can be distinguished as a function of the potential applied [P. N. Ross and H. Sokol. J. of Electrochemical Society, 131 (1984), 8, 1742-1749]:
between 530 and 580 mV vs. SHE, the predominant process is the reaction for the dissolution of the carbon to give carbonate ions;
between 580 and 680 mV vs. SHE, the release of oxygen and the dissolution of the carbon take place at equivalent rates;
whereas, for potentials greater than 680 mV vs. SHE, the release of oxygen and the production of carbon monoxide become the dominant reactions.

As the charging potential of the battery is very high (E_{charging}>0.85V vs. SHE [4]: [A. D'ebart et al./Journal of Power Sources, 174 (2007), 1177-1182]), these corrosion reactions always take place, both in acidic medium and in basic medium.

Several solutions have been provided in the state of the art for reducing or suppressing the corrosion of the carbon at the cathode, such as the use of two different electrodes for the charging and the discharging: [Development of a New-type Lithium Air Battery with Large Capacity, AIST press release of Feb. 24, 2009, http://www.aist.go.jp/aist e/latest research/2009/20090727/20090727.html; P. Stevens, Projet LIO [LIO Project], Faisabilité d'une batterie lithium air, Séminaire miparcours édition Stock-e 2007 [Feasibility of a lithium-air battery, mid-term seminar, publication Stock-e 2007], December 2009] or also the modification of the nature of the carbon support (use of carbon supports which are more resistant to corrosion, such as carbon nanotubes [patent US 2011/0104576 A1]). Even though these supports are supposed to be less sensitive to corrosion, they are all the same sensitive and decompose only slightly less rapidly than their equivalents based on carbon black.

Thus, in order to solve the problem mentioned generally in the literature, which is in agreement in saying that the majority of the limitations in the charging and discharging capacity of the lithium-air battery originate in part from inadequate design of the air electrode, harmful to the commercialization of lithium-air batteries, a subject matter of the present invention is an improved cathode for a lithium-air battery, composed of two layers based on at least two different types of supported catalysts.

A first layer in contact with the electrolyte comprises a first type of catalyst supported on electron-conducting particles, promoting the reaction for the oxidation of the products resulting from the discharging of the battery (LiO2, Li₂O₂).

A second layer in contact with the gas source comprises a second type of catalyst supported on electron-conducting particles, promoting the reaction for the reduction of the oxygen (discharging of the battery).

More specifically, a subject matter of the present invention is a catalytic cathode intended for a lithium-air battery comprising catalytic particles supported on electron-conducting particles, said cathode comprising a first face intended to be in contact with an ion-conducting material and a second face intended to be in contact with atmospheric oxygen, characterized in that said cathode comprising at least
one first catalytic layer intended to be in contact with the ion-conducting material and
one second catalytic layer intended to be in contact with atmospheric oxygen, characterized in that:
said first layer comprises first entities of catalytic particles promoting the reaction for the oxidation of lithium-based products, said entities being based on cobalt or on nickel;
said second layer comprises second entities of catalytic particles promoting the reaction for the reduction of oxygen, said second entities being based on manganese or on silver or on platinum.

According to an alternative form of the invention, said first and second layers comprise a binder which conducts lithium ions.

According to an alternative form of the invention, the first layers comprise a polymer binder which can be polytetrafluoroethylene or polyvinylidene fluoride.

A higher content of binder which conducts lithium ions can advantageously be used in the active layer which catalyzes the reaction for charging the battery (more hydrophilic layer) and a lower content in that which catalyzes the reaction for discharging the battery (more hydrophobic layer). This is why, according to an alternative form of the invention, the concentration by weight of binder in the first catalytic layer is greater than the concentration by weight of binder in the second catalytic layer.

According to an alternative form of the invention, the concentration by weight of binder in said first layer is between approximately 20% and 40%.

According to an alternative form of the invention, the concentration by weight of binder in said second layer is between approximately 10% and 30%.

According to an alternative form of the invention, at least the first catalytic entity or the second catalytic entity comprises a metal oxide.

According to an alternative form of the invention, the electron-conducting particles are particles of metal carbide or metal nitride based on a refractory metal which can be titanium or tantalum or tungsten.

According to an alternative form of the invention, the two layers are supported by a current collector which can be made of nickel or of titanium.

Another subject matter of the invention is a lithium-air battery comprising a lithium-based anode, an electrolytic which conducts lithium ions and a catalytic air cathode, the catalytic cathode being according to the present invention.

Advantageously, the lithium-air battery of the invention comprises a solid electrolyte material based on an organic polymer which conducts Li⁺ ions.

This is because, generally, as the electrolyte in contact with the air electrode is liquid (aqueous or organic), causes problems of wettability of the cathode electrode (R. Padbury and X. Zhang, J. of Power Sources, 196 (2011), 4436-4444) and requires the use of a compartment filled with liquid electrolyte, rendering the battery more complex and increasing its weight.

The assembly thus formed and composed of a solid electrolyte and of the catalytic cathode makes it possible to combine perfect wettability of the electrode, and thus the establishment of numerous regions of triple points as a result of the presence of the ionomer which conducts the lithium ions, while offering a much greater specific surface than the electrodes deposited on a nickel mesh of the prior art.

According to an alternative form of the invention, the organic polymer is a sulfonated organic polymer, for example a perfluorosulfonated polymer (PFSA) or a sulfonated polyetheretherketone (s-PEEK) or a sulfonated polyamide (s-PI) or a polyvinylidene fluoride (PVDF).

According to an alternative form of the invention, the organic polymer is a lithiated polymer.

A better understanding of the invention will be obtained and other advantages will become apparent on reading the description which will follow, given without implied limitation, and by virtue of the appended figures, among which:

FIG. 1 gives a diagrammatic representation of a lithium-air fuel cell of the known art;

FIG. 2 illustrates a structure of a catalytic air cathode according to the invention composed of a hydrophilic catalytic layer which catalyzes the reaction for charging the battery and of a more hydrophobic catalytic layer which promotes the reduction of the oxygen;

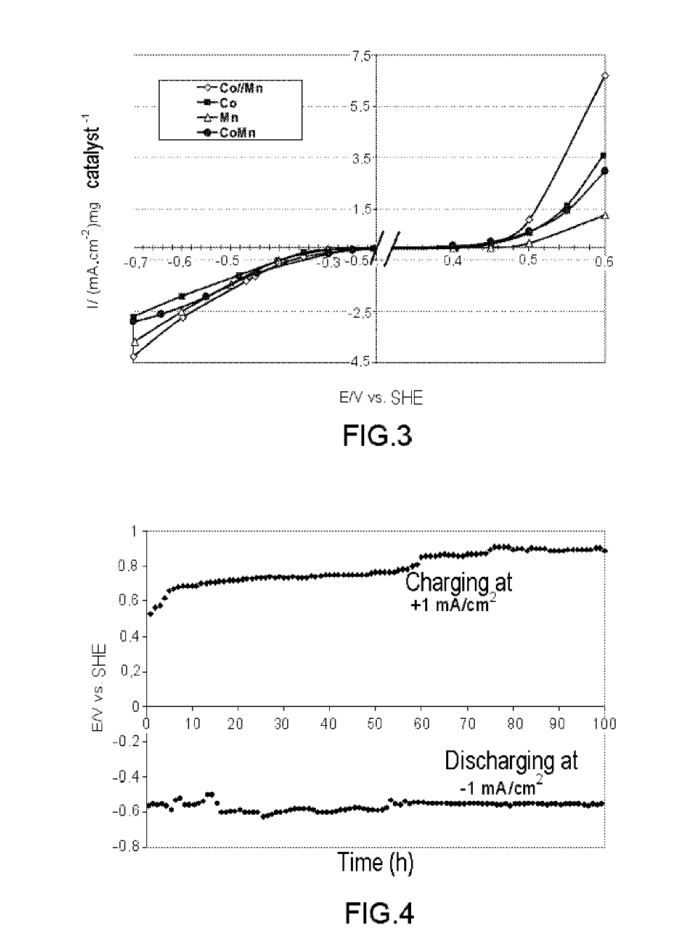

FIG. 3 illustrates the improvement in the electrochemical performance during the use of an air cathode comprising two layers according to the invention (a layer of cobalt supported on titanium carbide comprising 30% of ionomer which conducts lithium ions/a layer of manganese supported on titanium carbide comprising 20% of ionomer which conducts lithium ions), in comparison with a single-layer air electrode;

FIG. 4 illustrates the change in the performance of an air cathode of the invention over 200 charging/discharging cycles at ±1 mA·cm⁻².

Generally, the catalytic cathode of the invention comprises an assembly of two layers each comprising a catalytic entity providing a different function. Thus, as represented in FIG. 2, the cathode 30 used in a lithium-air battery comprises a first layer 31 intended to be in contact with the electrolyte which conducts lithium ions and a second layer 32 intended to be in contact with the inflow of air laden with O₂.

The catalysts are generally supported on carbon particles. With the aim of improving the resistance of the electrodes to air (corrosion of the carbon-based supports at the operating potentials of the battery), it can be advantageous to replace the carbon with metal carbides or nitrides, materials which are more stable over the ranges of potentials used, such as titanium carbide, tantalum carbide or tungsten carbide, and titanium nitride. In order to be of use as catalyst support, the material must be a good electron conductor and exhibit a broad specific surface.

Titanium carbide with an electrical conductivity similar to metals and a specific surface of the order of 25 m²·g⁻¹ constitutes a very well suited catalyst support.

The interfacial electrochemical reactions for charging and discharging the lithium-air battery take place solely when the electrolyte, the electrons and the gas molecules coexist at one and the same interface, also known as triple point. Thus, an effective air electrode must allow the catalyst to be easily accessible to the Li⁺ ions present in the electrolyte, while leaving the molecular oxygen with a broad path for diffusion.

Most specifically and according to an example of the present invention, the cathode is composed of two layers:
the first layer in contact with the electrolyte comprises a catalyst promoting the reaction for the oxidation of the products resulting from the discharging of the battery (LiO₂, Li₂O₂) which can be a cobalt oxide;
the second layer in contact with the gas source comprises a catalyst promoting the reaction for the reduction of the oxygen (discharging of the battery) which can be a manganese oxide.

The catalytic particles can be supported by particles of TiC carbide.

In order to obtain both types of constituent layers of the cathode, use is made of a binder and a solvent. Suspensions are produced which can be deposited on an electron-conducting support (metal mesh of nickel, titanium, steel, and the like) by a printing technique (coating, spraying, silkscreen printing, and the like).

The binder used within the electrode must be a material which conducts lithium ions. Concentration gradients in the two active layers of this binder which conducts lithium ions make it possible to promote either the moistening of the layer or the access to the gas. Thus, a high content of binder which conducts lithium ions can advantageously be used in the active layer which catalyzes the reaction for charging the battery (more hydrophilic layer) and a lower content in that which catalyzes the reaction for discharging the battery (more hydrophobic layer).

### Examples of the Preparation of a Cathode According to the Invention

The powders of catalysts supported on titanium carbide are prepared by chemical reduction of a metal salt of the catalyst by sodium borohydride. These powders are subsequently dispersed in inks, the compositions of which are given below:

Hydrophilic layer:
50 mg of powder of cobalt supported on TiC
30% by weight of binder which conducts lithium ions
0.2 g of deionized water
0.2 g of isopropanol.
   More hydrophobic layer:
50 mg of powder of manganese supported on Tic
20% by weight of binder which conducts lithium ions
0.2 g of deionized water
0.2 g of isopropanol.

FIG. 2 illustrates the improvement in the electrochemical performance during the use of an air electrode made of two layers (a layer of cobalt supported on titanium carbide comprising 30% of ionomer which conducts lithium ions/a layer of manganese supported on titanium carbide comprising 20% of ionomer which conducts lithium ions), in comparison with a single-layer air electrode. Medium 1M LiOH, sweeping at 5 mV·s⁻¹.

The applicant has monitored the change in the performance over time of this cathode (with a catalytic layer based on cobalt and a catalytic layer based on manganese) supported on titanium carbide, Nafion® membrane and current collector made of titanium) was tested under oxygen in a 1M LiOH medium.

The cathode was subjected to 200 charging/discharging cycles with a duration of 30 min at ±1 mA/cm². These tests were carried out over more than 100 hours and did not exhibit distinctive modifications in the charging and discharging potentials, as illustrated in FIG. 4, which shows the performance of the air cathode over 200 charging/discharging cycles at ±1 mA·cm⁻².

The difference in potential between the charging and the discharging is approximately 1.1 V over the entire duration of the cycles. These results exhibit a significant improvement in comparison with the use of a second electrode for the release of oxygen, also making it possible to prevent the corrosion of the carbon.

1. A catalytic cathode intended for a lithium-air battery comprising catalytic particles supported on electron-conducting particles, said cathode comprising a first face intended to be in contact with an ion-conducting material and a second face intended to be in contact with atmospheric oxygen, said cathode comprising at least:
a first catalytic layer intended to be in contact with the ion-conducting material and
a second catalytic layer intended to be in contact with atmospheric oxygen;
wherein said first layer comprises first entities of catalytic particles promoting the reaction for the oxidation of lithium-based products, said entities being based on cobalt or on nickel; and
wherein said second catalytic layer comprises second entities of catalytic particles promoting the reaction for the reduction of oxygen, said second entities being based on manganese or on silver or on platinum.

2. The catalytic cathode as claimed in claim 1, in which said first and second layers comprise a binder which conducts Li⁺ ions.

3. The catalytic cathode as claimed in claim 2, in which the concentration by weight of binder in the first catalytic layer is greater than the concentration by weight of binder in the second catalytic layer.

4. The catalytic cathode as claimed in claim 2, in which the concentration by weight of binder in said first layer is between approximately 20% and 40%.

5. The catalytic cathode as claimed in claim 2, in which the concentration by weight of binder in said second layer is between approximately 10% and 30%.

6. The catalytic cathode as claimed in claim 2, in which the binder is a polymer binder which can be polytetrafluoroethylene or polyvinylidene fluoride.

7. The catalytic cathode as claimed in claim 1, in which the electron-conducting support particles are particles of metal carbide based on a refractory metal which can be titanium or tantalum or tungsten.

8. The catalytic cathode as claimed in claim 1, in which the two layers are supported by a current collector which can be made of titanium.

9. A lithium-air battery comprising a lithium-based anode, an electrolyte which conducts lithium ions and a catalytic air cathode, the catalytic cathode being as claimed in claim 1.

10. The lithium-air battery as claimed in claim 9, in which the electrolyte which conducts lithium ions comprises a solid electrolyte material based on an organic polymer which conducts lithium ions, in contact with said catalytic cathode.

11. The lithium-air battery as claimed in claim 10, in which the organic polymer is a sulfonated organic polymer, for example a perfluorosulfonated polymer (PFSA) or a sulfonated polyetheretherketone (s-PEEK) or a sulfonated polyamide (s-PI) or a polyvinylidene fluoride (PVDF).

12. The lithium-air battery as claimed in claim 11, in which the organic polymer is a lithiated polymer.
